(19) United States
(12) Patent Application Publication
(10) Pub. No.: US 2026/0030357 A1
(43) Pub. Date: Jan. 29, 2026

(54) ELECTRONIC SYSTEM, CONTROLLER, OPERATING METHOD AND MEMORY SYSTEM

(71) Applicant: YANGTZE MEMORY TECHNOLOGIES CO., LTD., Wuhan (CN)

(72) Inventor: Ao HUANG, Wuhan (CN)

(21) Appl. No.: 18/935,089

(22) Filed: Nov. 1, 2024

(30) Foreign Application Priority Data
Jul. 24, 2024 (CN) 2024110043755

(51) Int. Cl. G06F 21/57; G06F 13/16

(52) U.S. Cl. CPC G06F 21/572; G06F 13/1668; G06F 21/575

(57) ABSTRACT

The present disclosure discloses an electronic system, a controller, an operating method and a memory system, which relates to the field of memory technology. The electronic system comprises a controller and a host, wherein the controller is coupled with the host and configured with first information, and the first information is to indicate that there is a first memory space in the controller; the host is configured to read the first information from the controller, and write the firmware image into the first memory space based on the first information. In the above electronic systems, the download of the firmware image does not need to rely on a firmware download command of NVMe, and the implementation process is simpler.

### CROSS-REFERENCE TO RELATED APPLICATIONS

The present application claims priority to Chinese Patent Application No. 2024110043755, which was filed Jul. 24, 2024, and is hereby incorporated herein by reference in its entirety.

### FIELD OF TECHNOLOGY

Examples of the present disclosure relate to the field of memory technology, in particular to an electronic system, a controller, an operating method and a memory system.

### BACKGROUND

In Non-Volatile Memory express (NVMe), a controller of the memory device may download a Firmware image in the host based on a Firmware Download command sent by the host.

To implement the firmware image download, the controller needs to support NVMe.

### SUMMARY

Examples of the present disclosure provide an electronic system, a controller, an operating method, and a memory system. A technical scheme provided in examples of the present disclosure is as follows:

According to one aspect of the examples of the present disclosure, an electronic system is provided, wherein the electronic system comprises a controller and a host, the controller is coupled with the host and configured with first information, and the first information is to indicate that there is a first memory space in the controller;
the host is configured to read the first information from the controller and write the firmware image into the first memory space based on the first information.

According to one aspect of the examples of the present disclosure, a controller is provided, wherein the controller comprises a processor;
the processor is configured to configure the first information in the controller, wherein the first information is to indicate that there is a first memory space in the controller for a host to write a firmware image.

According to one aspect of the examples of the present disclosure, an operating method of a host is provided, wherein the host is coupled with a controller configured with first information, and the first information is to indicate that there is a first memory space in the controller; wherein the method comprises:
reading the first information from the controller;
writing the firmware image into the first memory space based on the first information.

According to one aspect of the examples of the present disclosure, an operating method of a controller is provided, and the controller is coupled with a host;
the method comprises:
configuring first information in the controller, wherein the first information is to indicate that there is a first memory space in the controller for a host to write a firmware image.

According to one aspect of the examples of the present disclosure, a memory system is provided, wherein the memory system comprises the controller and at least one memory device coupled to the controller.

According to one aspect of the examples of the present disclosure, a host is provided, wherein the host comprises a host memory device and a host processor, and the host memory device stores a computer program that is loaded and executed by the host processor to implement the operating method of the host.

According to one aspect of the examples of the present disclosure, a computer readable memory medium is provided, wherein the computer readable memory medium stores a computer program that is loaded and executed by a processor to implement the operating method of the host or to implement the operating method of the controller.

According to one aspect of the examples of the present disclosure, a computer program product is provided, wherein the computer program product comprises a computer program that stored in a computer readable memory medium, and a processor reads from the computer readable memory medium and executes the computer program to implement the operating method of the host or to implement the operating method of the controller.

The technical solution provided by examples of the present disclosure includes at least the following beneficial effects:

Indicating to the host in the electronic system that there is a first memory space in the controller available for the host to write a firmware image, by configuring first information in the controller of an electronic system. Only the first information needs to be configured to enable firmware image transfer between the controller and the host. It can be seen that in the above electronic system, the download of the firmware image does not need to rely on a firmware download command of NVMe, and the implementation process is simpler.

### BRIEF DESCRIPTION OF THE DRAWINGS

FIG. 1 is a schematic diagram of an electronic system provided by one example of the present disclosure.

FIG. 2 is a schematic diagram of an electronic system provided by another example of the present disclosure.

FIG. 3 is a schematic diagram of a first memory space provided by one example of the present disclosure.

FIG. 4 is a schematic diagram of interaction process between a controller and a host provided by one example of the present disclosure.

FIG. 5 is a schematic diagram of a controller provided by one example of the present disclosure.

FIG. 6 is a flowchart of an operating method of a host provided by one example of the present disclosure.

FIG. 7 is a flowchart of an operating method of a controller provided by one example of the present disclosure.

FIG. 8 is a schematic diagram of a memory system provided by one example of the present disclosure.

FIG. 9 is a schematic diagram of a memory card provided by one example of the present disclosure.

FIG. 10 is a schematic diagram of a solid-state drive provided by one example of the present disclosure.

FIG. 11 is a structural diagram of a host provided by one example of the present disclosure.

### DETAILED DESCRIPTION

In order to make the purpose, technical scheme and advantages of the present disclosure clearer, the implementation of the present disclosure will be further described in detail in combination with the attached drawings.

Examples of the present disclosure include at least some of the followings.

A controller is a device configured to monitor, control and regulate the operating state of the system. The controller referred to in examples of the present disclosure may be memory controllers configured to control a memory system or controllers in various other electronic systems.

Firmware is a program that is solidified in the hardware device within the system and configured to drive the system. The firmware is stored in Non-Volatile Memory (NVM), for example, the firmware is stored in Read-Only Memory (ROM), and also, for example, the firmware is stored in Flash (flash memory). The memory controller can be configured to run the firmware in the memory system to achieve the control of the memory system.

An image is an executable independent software package configured to package the running environment of the software and the software developed based on the running environment, including all the content required to run the software, for example, the image includes the software's program code, runtime, libraries, environment variables and configuration information, etc.

A firmware image can be regarded as an image of the firmware, and the firmware image includes all the content required for the firmware to run. Therefore, the firmware image is portable and can be transferred from one device to another device to run. In some examples, the firmware image includes the code of the firmware and the configuration information of the firmware.

In some examples, the controller of the memory device downloads the Firmware image in the host based on the Firmware Download command sent by the host.

However, the firmware download command is specified by NVMe, and in order to implement firmware image download based on the firmware download command, the controller needs to support NVMe, for example, the firmware required to implement NVMe needs to be solidified in the controller, and the firmware can be configured to implement processing of the firmware download command. However, it can also implement a number of features specified by NVMe that are not related to firmware image downloading.

It can be seen that downloading the firmware image using the technical solution provided in the above examples will cause the firmware solidified in the controller more complex.

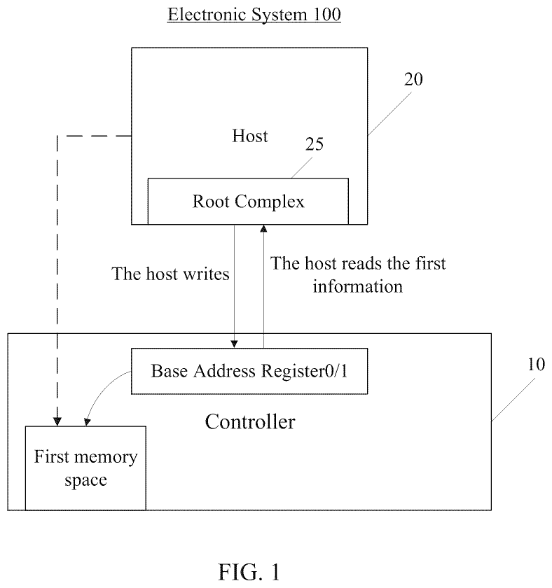

Referring to FIG. 1 illustrating a schematic diagram of an electronic system provided by one example of the present disclosure, the electronic system 100 comprises a controller 10 and a host 20, wherein the controller 10 is coupled with the host 20 and configured with first information, and the first information is to indicate that there is a first memory space in the controller 10.

The host 20 is configured to read the first information from the controller 10 and write a firmware image into the first memory space based on the first information.

The first memory space in the controller 10 is the memory space for the host 20 to use (read and write), rather than the full memory space of the controller 10. In some examples, the first information is to indicate that there is a first memory space in the controller 10 for the host 20 to write a firmware image.

In examples of the present disclosure, the host may be any electronic device with information memory and processing functions, for example, the host is a firmware burning device dedicated to burning firmware to a memory system (such as a Solid State Drive (SSD)), and also, for example, the host is mobile phone, desktop computer, tablet, laptop and other electronic devices.

In some examples, the controller 10 includes a Peripheral Component Interconnect express (PCIe) interface through which the controller 10 is coupled to the host 20. That is, in this example, the controller 10 may be any controller that supports PCIe. It should be noted that NVMe is implemented based on PCIe, which is a more low-level protocol than NVMe. Therefore, the controller that supports PCIe may support NVMe or not. Therefore, the above solution has strong universality.

In some examples, referring to FIG. 1, the host 20 includes RC (Root Complex) 25, and the controller 10 is coupled to the Root Complex 25 via a PCIe interface. Also known as the root port, the Root Complex 25 comprises an interface between the host 20 and a PCIe bus through which the host 20 may be coupled with multiple PCIe devices (including the controller 10).

In some examples, referring to FIG. 1, the controller 10 includes a Base Address Register (BAR), and the first information is configured in the BAR. In some examples, the first information is the value of BAR, and the host 20 is configured to read the value of BAR in the controller 10 to obtain the first information.

In some examples, the controller 10 includes a plurality of BARs, and the first information is configured in all or part of the plurality of BARs, for example, the controller 10 includes BARs 0˜5, and the first information is configured in BAR 0/1, and also, for example, the controller 10 includes BAR 0 and BAR 1, and the first information is configured in BAR 0 and BAR 1, or, the first information is configured in BAR 0 or BAR 1.

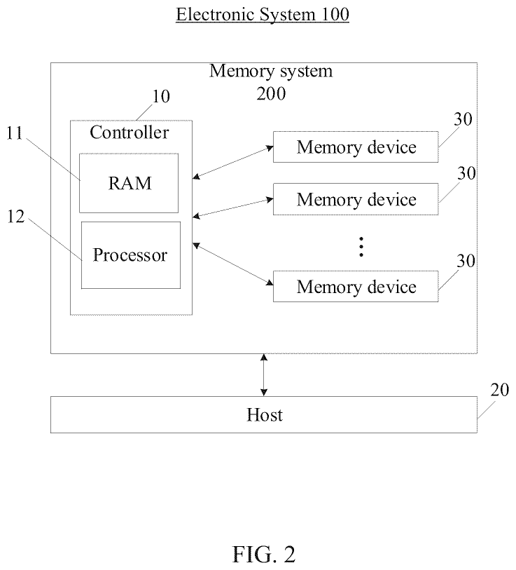

In some examples, the controller 10 is a memory controller, referring to FIG. 2, and the electronic system 100 also includes a memory device 30, which is coupled with the controller 10.

In some examples, referring to FIG. 2, the controller 10 and one or more memory devices 30 are integrated in a memory system 200. In other words, the electronic system 100 includes the host 20 and the memory system 200. For details about memory system 200, reference is made to the following examples which are not described in detail here

In some examples, the memory device 30 is non-volatile memory device, such as flash memory. For example, the memory device 30 is NAND (Not AND, and not) flash, NOR (Not OR, or not) flash, etc.

In some examples, referring to FIG. 2, the controller 10 comprises a memory 11 including the first memory space. In some examples, the memory 11 is Volatile Memory (VM) device. In some examples, the memory 11 is Random-Access memory (RAM) device, for example, the memory 11 is Static RAM (SRAM) device.

In some examples, the firmware image includes stored data, and the controller 10 is configured to write the stored data into the memory device 30 (such as NAND flash). The stored data refers to the data in the firmware image that needs to be saved in the memory system 200, such as the code and configuration information of the firmware, etc. Since the first memory space belongs to the memory 11 and the data in the memory 11 cannot be saved after the controller 10 is powered off, the stored data needs to be written into the memory device 30 for saving.

Since the memory 11 has a faster read and write rate, the process of writing firmware image to the first memory space may achieve a faster rate (for example, obtain a faster firmware image download speed), and thus improving product efficiency.

In some examples, the first information is also to indicate the size of the first memory space, for example, the first information is to indicate the size of the memory space in the controller 10 for the host 20 to use.

In some examples, the value of the BAR is to indicate the size of the first memory space.

In some examples, the host 20 is further configured to assign an address corresponding to the first memory space based on the size of the first memory space, and write the firmware image into the first memory space based on the address.

Note that the address assigned by the host 20 to the first memory space is the address of the first memory space on the host side, which is different from the address of the first memory space on the controller side, and the address is assigned by the host 20 according to its own address assignment. For example, if the host 20 has assigned addresses A and B, the host 20 will assign a new address C as the address of the first memory space, and will not reassign the already assigned addresses A and B.

In addition, it should be noted that in the example of the present disclosure, after the controller 10 exposes the first memory space to the host 20 through the first information, the controller 10 is considered to have only the first memory space on the host side, for example, the address assigned by the host 20 to the first memory space can also be regarded as the address assigned by the host 20 to the controller 10. This address is independent of the address of the first memory space on the controller side. During the process of the host 20 writing data into the controller 10 based on this address, the controller 10 can spontaneously assign the first memory space to store the data transmitted by the host (based on the address of the first memory space on the controller side). For example, the host 20 transmits data to the controller 10 through the PCIe bus, and the controller 10 assigns the first memory space to store data uploading from the PCIe bus. Therefore, the host 20 does not need to know the address of the first memory space on the controller side. Instead, the host 20 writes a firmware image into the controller 10 based on the address assigned to the first memory space by its own (for example, the address assigned to the controller 10), and then writes the firmware image into the first memory space.

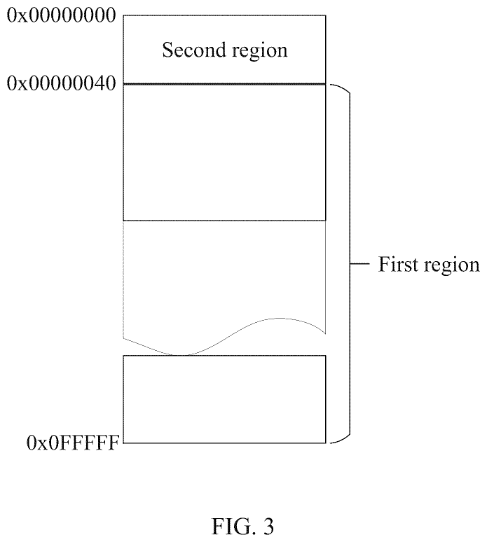

The address assigned to the first memory space by the host 20 needs to conform to the size of the first memory space. For example, referring to FIG. 3, the size of the first memory space is 1 MB and the address assigned to the first memory space ranges from 0x00000000 to 0x0FFFFF.

In some examples, referring to FIG. 3, the first memory space includes a first region and a second region.

In some examples, the host 20 is also configured to write second information into the second region after writing the firmware image into the first region.

The second information is to indicate that the host 20 has written the firmware image into the first region, for example, the second information is a flag indicating the completion of writing the firmware image, for example, the second information is “IMGREADY (IMG is ready)”. Therefore, the second region for storing the second information can also be referred to as the “CompletionFlag” region.

In some examples, the address includes the address of the first region and the second region, and the host 20 is also configured to write the second information into the second region based on the address of the second region after writing the firmware image to the first region based on the address of the first region.

In some examples, the size of the first region is greater than the size of the second region.

For example, referring to FIG. 3, the size of the second region is 64 bytes and the address range is 0x00000000 to 0x00000040, and the size of the first region is (1M-64) bytes and the address range is 0x00000040 to 0x0FFFFF.

In some examples, the controller 10 is configured to process the firmware image in the first region in the case that the second information exists in the second region.

The first region is to store the firmware image.

In some examples, referring to FIG. 2, the controller 10 includes the processor 12 configured to verify the firmware image in the case that the second information exists in the second region, and to run the firmware image in the case that the firmware image passes the verification.

In some examples, the processor 12 is a Microcontroller Unit (MCU).

In some examples, the processor 12 is configured to detect whether there is second information in the second region according to a set time interval (e.g., 1 s, 5 s, 10 s).

In some examples, the processor 12 is configured to verify the integrity and/or security of the firmware image (e.g., verify the firmware image) according to the set criteria in the case that the second information exists in the second region.

In some examples, the firmware image includes the stored data, and the processor 12 is configured to run the firmware image to write the stored data into the memory device 30 in the case that the firmware image passes the verification.

In some examples, the firmware image may also not include the stored data, e.g., it is not required to solidify the contents of the firmware image into the memory system 200, and the processor 12 is configured to run the firmware image in the case that the firmware image passes the verification, to perform a functional test against the memory system 200 (for example, to test various functions of the memory system 200, and after the test is complete, the firmware image does not need to be saved).

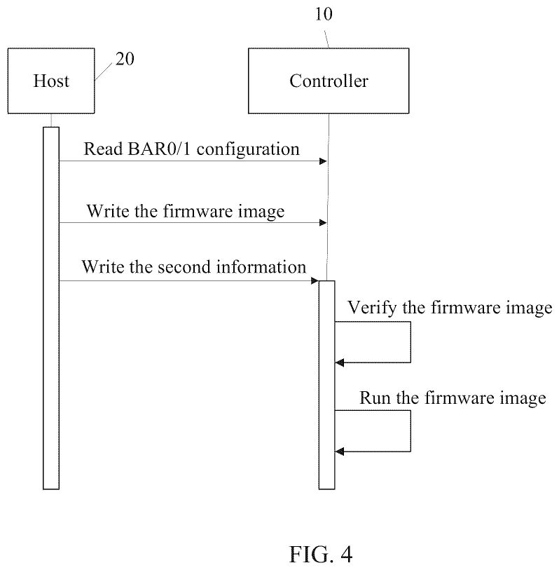

In summary, referring to FIG. 4, in the electronic system 100 provided by examples of the present disclosure, the interaction process between the controller 10 and the host 20 comprises the following operations:
1. The host 20 reads the first information from the controller 10, for example, the host 20 reads the first information by reading the configuration of BARO/1 in the controller 10.
2. The host 20 writes the firmware image to the controller 10 (the first memory space in the controller 10) according to the first information.
3. After writing the firmware image to the controller 10 (the first region in the first memory space), the host 20 writes the second information to the controller 10 (the second region in the first memory space).
4. The controller 10 verifies the firmware image after detecting the second information.
5. The controller 10 runs the firmware image in the case that the firmware image passes the verification.

The technical solution provided by examples of the present disclosure indicates to the host in the electronic system that there is a first memory space in the controller available for the host to write a firmware image, by configuring the first information in the controller in the electronic system. Only the first information needs to be configured to enable firmware image transfer between the controller and the host. It can be seen that in the above electronic system, the download of the firmware image does not need to rely on a firmware download command of NVMe, and the implementation process is simpler.

In addition, in the above electronic system, only the firmware required for the configuration of the first information needs to be solidified in the controller, and the firmware does not need to support NVMe, which has lower complexity and therefore has higher reliability.

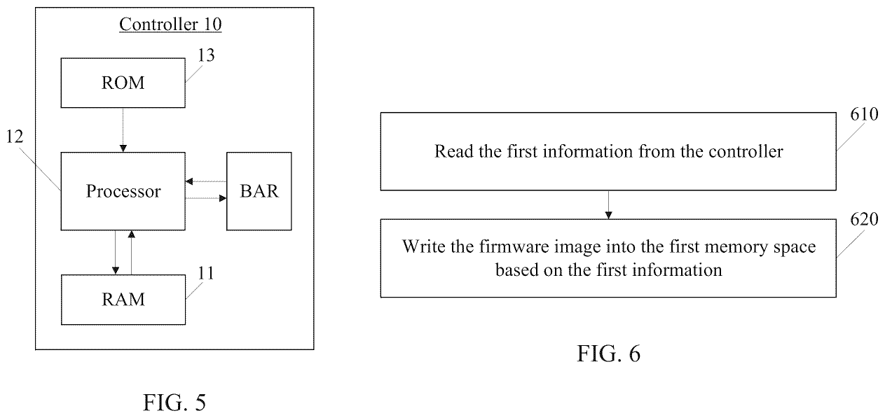

Referring to FIG. 5 illustrating a schematic diagram of the controller provided by one example of the present disclosure, the controller 10 comprises the processor 12 configured to configure first information in the controller 10, wherein the first information is to indicate that there is a first memory space in the controller for the host (such as the host 20 in the above examples) to write firmware image.

In some examples, the controller 10 includes a PCIe interface through which the controller 10 is coupled to the host.

In some examples, referring to FIG. 5, the controller includes a BAR (e.g., BAR0/1), and the first information is configured in the BAR. In some examples, the processor 12 is further configured to configure the first information, by configuring the value of BAR.

In some examples, referring to FIG. 5, the controller 10 also includes the memory 11 (such as RAM), which includes the first memory space.

In some examples, the first memory space includes a first region and a second region; the processor 12 is also configured to process the firmware image in the first region in the case that the second information exists in the second region, wherein the second information is to indicate that the host has written the firmware image into the first region.

In some examples, the processor 12 is further configured to verify the firmware image in the case that the second information exists in the second region, and to run the firmware image in the case that the firmware image passes the verification.

In some examples, the first information is also to indicate the size of the first memory space. In some examples, the processor 12 is further configured to indicate the size of the first memory space by configuring the value of BAR.

In some examples, the controller 10 is coupled to the memory device (such as the memory device 30 in the above examples), and the firmware image includes the stored data; the processor 12 is also configured to write the stored data into the memory device. In some examples, the processor 12 is configured to run the firmware image to write the stored data into the memory device in the case that the firmware image passes the verification.

In some examples, referring to FIG. 5, the controller 10 also includes ROM 13 where the first firmware is stored and the processor 12 is configured to run the first firmware to configure the first information in the controller 10.

In some examples, the processor 12 is configured to run the first firmware, initialize the controller 10 according to the PCIe protocol (including initializing the memory 11 and/or BAR), and then configure the first information in the controller 10.

In some examples, the processor 12 is also configured to run the first firmware to process the firmware image in the first region in the case that the second information exists in the second region, wherein the second information is to indicate that the host has written the firmware image into the first region.

In some examples, the processor 12 is further configured to run the first firmware to verify the firmware image in the case that the second information exists in the second region, and to run the firmware image in the case that the firmware image passes the verification.

In some examples, the first firmware is the boot program for the controller 10, wherein the boot program is the firmware that runs when the controller 10 is powered on and booted, and ROM 13 is the boot ROM for the controller 10 to store the boot program (start the ROM).

In some examples, the processor 12 is further configured to run the first firmware when the controller 10 is powered on and booted.

In some examples, when the coupling relationship between the controller 10 and the host is established and the host supplies power to the controller 10, the controller 10 is powered on and booted. In some examples, the controller 10 includes a PCIe interface through which the controller 10 is coupled to the host. In this case, combined with the technical solution provided in the above examples, the present disclosure implements a new PCIe startup mode with simple logic and high reliability, in which the firmware image can be downloaded to the controller 10 without requiring the controller 10 to start in NVMe mode.

The technical solution provided in examples of the present disclosure indicates to the host that there is a first memory space in the controller 10 available for a host to write a firmware image, by configuring the first information in the controller 10. Only the first information needs to be configured to enable firmware image transfer between the controller 10 and the host. It can be seen that with the above solution, the download of the firmware image does not need to rely on a firmware download command of NVMe, and thus the implementation process is simpler.

In addition, in the above controller, only the firmware required for the configuration of the first information (for example, the first firmware) needs to be solidified, which does not need to support NVMe and has low complexity and therefore has high reliability.

Referring to FIG. 6 illustrating a flowchart of an operating method of a host provided by one example of the present disclosure, the execution subject of each operation of the method is a host, such as the host 20 in the above examples. The host is coupled to a controller, such as the controller 10 in the above examples, and the controller is configured with the first information that indicates there is a first memory space in the controller.

The method includes at least one of the following operations 610 to 620.

Operation 610, reading the first information from the controller.

In some examples, the host reads the BAR in the controller to get the first information.

Operation 620, writing the firmware image into the first memory space based on the first information.

In some examples, the first information is also to indicate the size of the first memory space.

In some examples, the host reads BAR in the controller, and the value of the BAR indicates the size of the first memory space.

Operation 620 includes at least one of the following sub-operations 622 to 624.

Sub-operation 622, assigning an address corresponding to the first memory space based on the size of the first memory space.

It should be noted that after the host reads the first information, that is equivalent to the controller exposes the first memory space to the host, the host regards the first memory space as its own space and assigns an address to the first memory space according to its own address assignment.

Sub-operation 624, writing the firmware image into the first memory space based on the address.

In some examples, the first memory space includes a first region and a second region.

The operating method for the host also includes operation 630 (not shown in FIG. 6).

Operation 630, writing the second information into the second region after writing the firmware image into the first region, wherein the second information is to indicate that the host has written the firmware image into the first region.

The technical solution provided in examples of the present disclosure reads the first information configured in the controller by the host to write a firmware image into the controller. It can be seen that with the above solution, the download of the firmware image does not need to rely on a firmware download command of NVMe, and the implementation process is simpler. In addition, on the host side, see the above scheme, the firmware image can be transmitted to the controller only by implementing read of the first information, and the program code on the host side is also relatively simple and easy to maintain.

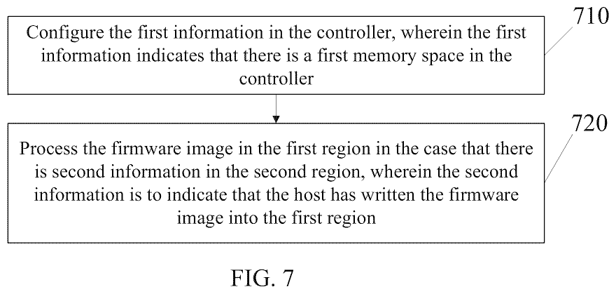

Referring to FIG. 7 illustrating a flowchart of an operating method of a controller provided by one example of the present disclosure, the executive subject of each operation of the method is a controller, such as the controller 10 in the above examples. The controller 10 is coupled to a host, for example, to the host 20 in the above examples, and the method comprises the following operation 710.

Operation 710, configuring first information in the controller, wherein the first information indicates that there is a first memory space in the controller.

The first memory space is for the host to write firmware image.

In some examples, the controller includes a PCIe interface through which the controller is coupled to the host, and the controller includes a BAR. Operation 710 includes: the controller configures the first information in the BAR. In some examples, the controller configures the first information by configuring the value of BAR.

In some examples, the first memory space includes a first region and a second region. The operating method of the above controller also includes operation 720.

Operation 720, processing the firmware image in the first region in the case that second information exists in the second region, wherein the second information is to indicate that the host has written the firmware image into the first region.

In some examples, operation 720 also includes at least one of the following sub- operations 722 to 724.

Sub-operation 722, verifying the firmware image in the case that the second information exists in the second region.

Sub-operation 724, running the firmware image in the case that the firmware image passes the verification.

The technical solution provided by examples of the present disclosure indicates to the host that there is a first memory space in the controller available for a host to write a firmware image, by configuring the first information in the controller. Only the first information needs to be configured to enable firmware image transfer between the controller and the host. With the above solution, the download of the firmware image does not need to rely on a firmware download command of NVMe, and the implementation process is simpler.

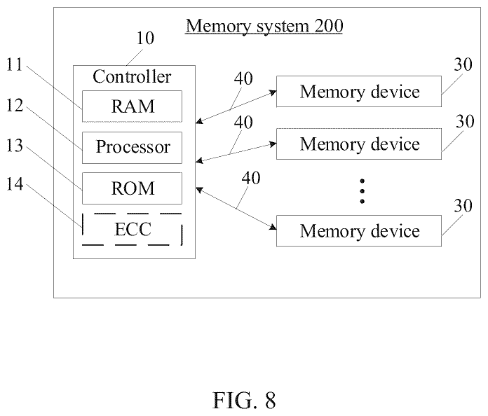

Referring to FIG. 8 illustrating a schematic diagram of the memory system provided by one example of the present disclosure, the memory system 200 includes a controller 10 and at least one memory device 30 coupled with the controller 10.

The memory system 200 may communicate with a host (for example, the host 20 in the above examples) through the controller 10, wherein the host may comprise a host processor, such as a Central Processing Unit (CPU), or a System on Chip (SoC), for example, an Application Processor (AP), and the host may send data to be stored in the memory system 200 and/or may retrieve data from the memory system 200. In some examples, when the memory system 200 is not coupled with the host, the controller 10 is in the power-off state, and when the memory system 200 is coupled with the host, the controller 10 in the memory system 200 is powered on and booted to implement the management of data transmission and control of the memory device 30, wherein the controller 10 may be connected to one or more memory devices 30 via one or more channels 40. In some examples, each memory device 30 may be managed by the controller 10 via one or more channels 40.

In some examples, the controller 10 can handle Input/Output (I/O) requests received from the host, ensure data integrity and efficient memory device, and manage the memory device 30. To perform these tasks, the controller 10 may run the firmware executable by one or more processors (e.g., micro processing units) of the controller 10. For example, the controller 10 may run the firmware to map logical addresses (for example, addresses used by the host associated with host data) to physical addresses in the memory device 30 (for example, actual locations where data is stored). The controller 10 may also run the firmware to manage defective memory blocks in the memory device 30, where the firmware may remap logical addresses to different physical addresses, for example, move data to different physical addresses. In some examples, the controller 10 also comprises the memory 11 (e.g., RAM), which can be configured to store various metadata used by the firmware.

The above firmware may be the first firmware stored in the ROM 13. The first firmware is the boot program of the controller 10 and is configured to perform operating method of the above controller. The firmware may also be the firmware stored in the memory device 30, which is not the boot program of the controller 10. In some examples, the firmware image is written by the host into the first memory space of the memory 11. After running the firmware image, the code and configuration information of the firmware included in the firmware image is written into the memory device 30, so that the firmware is solidified to the memory device 30.

In some examples, the controller 10 may also perform error recovery through the Error Correction Code (ECC) engine 14. The ECC engine 14 is configured to detect and correct raw bit errors that occur within each memory device 30.

In some examples, the channel 40 may provide data and control communication between the controller 10 and each memory device 30 via a Databus. The controller 10 can select a certain memory device 30 according to the chip enable signal.

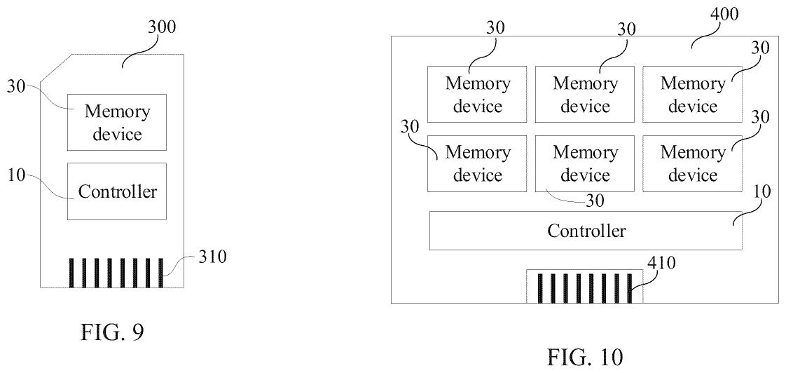

In some examples, the controller 10 and one or more memory devices 30 are included in the same package, such as Universal Flash Memory (UFS) package or embedded Multi Media Card (eMMC) package. In other words, the memory system 200 can be implemented and packaged into different types of terminal electronics. In an example shown in FIG. 9, the controller 10 and a single memory device 30 may be integrated into a memory card 300. The memory card 300 may include PC (PCMCIA, International Association of Personal Computer Memory) cards, Compact Flash (CF) cards, Smart Media (SM) cards, memory sticks, multimedia cards (MMC, RS-MMC, MMCmicro), SD cards (SD, miniSD, microSD, SDHC), UFS, etc. The memory card 300 may also include a memory card connector 310 that couples the memory card 300 with the host (for example, the host 20 in FIG. 1). In another example shown in FIG. 10, the controller 10 and multiple memory devices 30 may be integrated into the SSD400. The SSD400 may also include an SSD connector 410 that couples the SSD400 with a host (for example, the host 20 in FIG. 1).

The above memory system 200 may be one or more of a universal flash memory device, an embedded multimedia card, a universal flash memory multi-chip Package (UFS-based Multichip Package, uMCP) memory device, an embedded multimedia card multi-chip package (eMMC-based Multichip Package, eMCP) memory device, solid state drive, etc., which are not limited in the present disclosure.

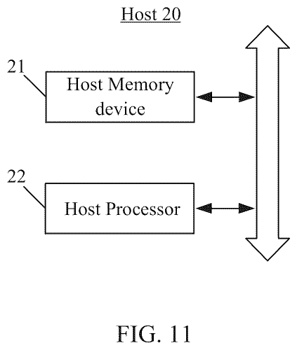

Referring to FIG. 11 illustrating the structural diagram of the host provided by one example of the present disclosure, the host 20 comprises a host memory device 21 and a host processor 22, wherein the host memory device 21 is stored with a computer program, and the computer program is loaded and executed by the host processor 22 to implement the operating method of the host.

The host processor 22 includes a CPU or system-on-chip (such as an application processor), and the host memory device 21 may include one or more computer-readable memory media that may be tangible and non-transient. The memory device may also include high-speed random access memory device, as well as non-volatile memory device, such as one or more disk memory systems, flash memory systems.

In some examples, the host memory device 21 is stored with the firmware image. In some examples, a non-transient computer-readable memory medium in host memory device 21 stores a computer program that is loaded and executed by the host processor 22 to implement the operating method of the host, so as to download a firmware image from the host 20 to a controller (such as the controller 10).

Examples of the present disclosure also provides a computer readable memory medium in which a computer program is stored, wherein the computer program is loaded and executed by a processor to implement the operating method of the host or to implement the operating method of the controller.

Optionally, the computer readable memory media may include: ROM, RAM, SSD, or optical disc. Among them, RAM may include Resistance Random Access Memory (ReRAM) and Dynamic Random Access Memory (DRAM), etc.

Examples of the present disclosure also provide a computer program product comprising a computer program stored in a computer readable memory medium from which a processor reads and executes the computer program to implement the operating method of the host (in this case, the computer program is stored in the host memory device), or to implement the operating method of the controller (in this case, the computer program is the first firmware stored in the controller).

It should be noted that the contents of the examples of the electronic system, controller, operating method of host, operating method of controller, memory system, host, computer readable memory medium, computer program product, etc. in the present disclosure are mutually common, and that any content not specified in one of the examples may be referred to the remaining examples.

It should be understood that the reference to “multiple” herein refers to two or more. “And/or” describes the association relationship of the associated object, indicating that there may be three kinds of relationships, for example, A and/or B, can represent: A exists alone, A and B exist simultaneously, and B exists alone. The character “/” generally indicates that the associated object is an “or” relationship. In addition, the numbering of the operations described herein only shows a possible sequence of execution between the operations by example. In some other examples, the above operations may also be executed in a different numbering order, such as two operations with different numbering at the same time, or two operations with different numbering in the opposite order to the illustration, which is not limited in examples of the present disclosure.

The above are only exemplary examples of the present disclosure and are not intended to limit the present disclosure. Any modification, equivalent substitution. improvement, etc. made within the spirit and principles of the present disclosure shall be included in the scope of protection of the present disclosure.

What is claimed is:

1. An electronic system, comprising:
a controller, wherein the controller is coupled with a host and configured with first information, the first information indicating that the controller comprises a first memory space; and
the host, wherein the host is configured to:
read the first information from the controller; and
responsive to reading the first information, write a firmware image into the first memory space based on the first information.

2. The electronic system of claim 1, wherein the controller comprises a Peripheral Component Interconnect express (PCIe) interface through which the controller is coupled to the host.

3. The electronic system of claim 2, wherein the controller comprises a Base Address Register (BAR), and the first information is configured in the BAR, and the first information comprises a value of the BAR.

4. The electronic system of claim 1, wherein the controller comprises a memory, and the memory comprises the first memory space.

5. The electronic system of claim 1, wherein the first information is further to indicate a size of the first memory space, and the host is further configured to:
assign an address corresponding to the first memory space based on the size of the first memory space; and
write the firmware image into the first memory space based on the address.

6. The electronic system of claim 1, wherein the first memory space comprises a first region and a second region, the host is further configured to write second information into the second region after writing the firmware image into the first region, and the controller is configured to process the firmware image in the first region responsive to the second information existing in the second region.

7. The electronic system of claim 6, wherein the controller comprises a processor configured to:
verify the firmware image responsive to the second information existing in the second region; and
run the firmware image responsive to the firmware image passing the verification.

8. The electronic system of claim 1, wherein the electronic system further comprises a memory device coupled with the controller, the firmware image comprises stored data, and the controller is configured to write the stored data into the memory device.

9. A controller, comprising:
a processor configured to:
configure first information in the controller, the first information indicating that there is a first memory space in the controller, the first memory space including first and second regions;
verify a firmware image stored in the first region responsive to second information existing in the second region; and
run the firmware image responsive to the firmware image passing the verification.

10. The controller of claim 9, wherein the controller comprises a Peripheral Component Interconnect express (PCIe) interface through which the controller is coupled to a host.

11. The controller of claim 10, wherein the controller comprises the Base Address Register (BAR), and the first information is configured in the BAR.

12. The controller of claim 9, wherein the controller further comprises a memory, and the memory comprises the first memory space.

13. The controller of claim 9, wherein the processor is further configured to process the firmware image in the first region responsive to the second information existing in the second region, wherein the second information is to indicate that a host has written the firmware image into the first region.

14. The controller of claim 9, wherein the controller is coupled with a memory device, the firmware image comprises stored data, and the controller is further configured to write the stored data into the memory device.

15. The controller of claim 9, wherein the controller further comprises a read-only memory device, a first firmware is stored in the read-only memory device, and the processor is configured to run the first firmware to configure the first information in the controller.

16. The controller of claim 15, wherein the processor is further configured to run the first firmware responsive to the controller being powered on and booted.

17. A method of operating a host coupled with a controller configured with first information indicating that there is a first memory space in the controller, wherein the method comprises:
reading the first information from the controller; and
writing a firmware image into the first memory space based on the first information.

18. The method of claim 17, wherein the first information is further to indicate a size of the first memory space, and
writing the firmware image into the first memory space based on the first information comprises:
assigning an address corresponding to the first memory space based on the size of the first memory space; and
writing the firmware image into the first memory space based on the address.

19. The method of claim 17, wherein the first memory space comprises a first region and a second region, and the method further comprises:
writing second information into the second region after writing the firmware image into the first region, wherein the second information is to indicate that the host has written the firmware image into the first region.

20. The method of claim 19, wherein the second information into the second region causes the controller to:
verify the firmware image; and
run the firmware image responsive to the firmware image passing the verification.
